(19) United States
(12) Patent Application Publication
(10) Pub. No.: US 2021/0191159 A1
(43) Pub. Date: Jun. 24, 2021

(54) Eyeglasses with Charging Interface

(71) Applicant: USOUND GMBH, Graz (AT)

(72) Inventors: Andrea Rusconi Clerici Beltrami, Wien (AT); Ferruccio Bottoni, Graz (AT)

(21) Appl. No.: 17/124,745

(22) Filed: Dec. 17, 2020

(30) Foreign Application Priority Data
Dec. 19, 2019 (DE) 10 2019 135 328.9
Jan. 30, 2020 (DE) 10 2020 102 281.6

(51) Int. Cl. G02C 11/00; G02C 5/14; G02C 11/06; H02J 7/00

(52) U.S. Cl. CPC G02C 11/10; H02J 7/0045; G02C 11/06; G02C 5/14

(57) ABSTRACT

A pair of eyeglasses for the input/output of visual and/or auditory information defines a lens holder for holding eyeglass lenses. The lens holder includes at least one first joint surface, at least one eyeglass temple, which comprises a second joint surface, and a temple joint associated with the eyeglass temple, via which the eyeglass temple is articulatedly connected to the lens holder in such a way that the first and second joint surfaces are folded away from each other in the folded state of the eyeglass temple and are folded toward each other in the unfolded state of the eyeglass temple. An energy store is arranged in the lens holder and/or the eyeglass temple along with a charging interface arranged at the first joint surface and/or the second joint surface and configured for charging the energy store.

### TECHNICAL FIELD

The present invention relates to a pair of eyeglasses for the input/output of visual and/or auditory information and having temples that articulate so as to be selectively foldable with respect to a lens holder for holding eyeglass lenses. The present invention further relates to a charging station for charging a pair of eyeglasses for the input/output of visual and/or auditory information and having temples that articulate so as to be selectively foldable with respect to a lens holder for holding eyeglass lenses.

### BACKGROUND

Eyeglasses for the input/output of visual and/or auditory information and having temples that articulate so as to be selectively foldable with respect to a lens holder for holding eyeglass lenses are disclosed in U.S. Pat. Nos. 9,482,882 and 9,971,169, each of which patent being hereby incorporated herein by this reference for all purposes. Such eyeglasses can include electronics that can be charged via a case that is used to transport and protect the eyeglasses.

The plug in connections for charging these eyeglasses can become soiled and loosen with repeated usage, and thus charging degrades over time without the exercise of vigilant inspection and maintenance by the user. The object of the present invention is to eliminate the disadvantages from the related art, in particular to avoid a soiling and/or damage of a charging interface of the eyeglasses and/or to ensure a reliable charging of the eyeglasses when these have been placed into a charging station.

### OBJECTS AND SUMMARY OF THE INVENTION

Each of the objects of the invention is achieved by means described below. The invention relates to a pair of eyeglasses for the input/output of visual and/or auditory information, with a lens holder for holding eyeglass lenses. The lens holder comprises at least one first joint surface. Moreover, the eyeglasses comprise at least one, preferably two, eyeglass temple(s). The eyeglass temple comprises a second joint surface. The eyeglasses comprise a temple joint associated with the eyeglass temple, via which the eyeglass temple is articulatedly connected to the lens holder, in particular in a joint area of the eyeglasses. The eyeglass temple is connected to the lens holder in such a way that the two joint surfaces are folded away from each other in the folded state of the eyeglass temple and are folded toward each other in the unfolded state of the eyeglass temple. Preferably, the two joint surfaces rest against one another at least in one area in the folded state. The eyeglasses also comprise an energy store, which is arranged in the lens holder and/or the eyeglass temple. The eyeglasses comprise a charging interface for charging the energy store. The charging interface is arranged at the first joint surface and/or the second joint surface. As a result, the charging interface is covered by the opposite joint surface in the unfolded state of the eyeglass temple. Advantageously, as a result, the design of the eyeglasses is not negatively affected by the charging interface. Moreover, in the unfolded state of the eyeglass temple, the charging interface of the one joint surface is protected from soiling and damage by the opposite, other joint surface. In the folded state of the eyeglass temple, the charging interface is exposed, so that this can be contacted to a current interface of a charging station.

It is advantageous when the charging interface comprises at least one charging contact. This is intended for a current interface of a charging station.

It is also advantageous when the charging contact is designed to be flat and/or designed as a metal surface. As a result, the two corresponding joint surfaces can rest closely against one another in the unfolded state.

It is advantageous when two charging contacts are arranged, in particular next to one another, in the first joint surface and/or the second joint surface.

Likewise, it is advantageous when the first joint surface and/or the second joint surface are/is designed to be flat.

It is advantageous when the first joint surface and/or the second joint surface extend(s) obliquely with respect to a longitudinal axis and/or transverse axis of the eyeglass temple.

It is also advantageous when the first joint surface and/or the second joint surface extend(s) radially with respect to a joint axis of the temple joint.

Moreover, it is advantageous when the first joint surface and/or the second joint surface are/is slanted by an angle of more or less than 90° with respect to a temple outer side of the eyeglass temple, in particular in a top view of the eyeglasses. When the first joint surface and/or the second joint surface are/is slanted by an angle of more than 90° with respect to the temple outer side of the eyeglass temple, an obtuse angle is formed between these two. When the first joint surface and/or the second joint surface are/is slanted by an angle of less than 90° with respect to the temple outer side of the eyeglass temple, an acute angle is formed between these two.

It is advantageous when, in the folded state of the two eyeglass temples, the two second joint surfaces of the two eyeglass temples, which are spaced apart from one another in the longitudinal direction of the lens holder, are slanted and/or arranged in a V-shaped manner with respect to one another in a top view of the eyeglasses. As a result, it can be ensured that the charging interface, in particular the at least one charging contact, of the eyeglass temple reliably comes into contact with a current interface of a charging station when the eyeglasses are placed into the charging station.

It is also advantageous when the eyeglasses comprise an audio system, in particular with a MEMS loudspeaker, which is electrically connected to the energy store.

Furthermore, the invention relates to a charging station for charging a pair of eyeglasses for the input/output of visual and/or auditory information, with an eyeglass receptacle, into which the eyeglasses, in the folded state, can be placed, and at least one current interface for charging an energy store of the eyeglasses. The charging station comprises at least one charging surface, in which the current interface is arranged.

It is advantageous when the charging surface extends obliquely with respect to a longitudinal axis and/or vertical axis of the charging station.

It is also advantageous when the current interface is designed to be magnetic. In this case, the charging interface is drawn toward the current interface.

It is advantageous when the charging station comprises two charging surfaces spaced apart from one another in the longitudinal direction of the charging station, which are slanted and/or arranged in a V-shaped manner with respect to one another. As a result, it can be ensured that the charging interface, in particular the least one charging contact, of the eyeglass temple reliably comes into contact with a current interface of the charging station when the eyeglasses are placed into the charging station.

The invention relates to an eyeglass charging system with a pair of eyeglasses for the input/output of visual and/or auditory information and a charging station for charging the eyeglasses. The eyeglasses and/or the charging station are/is designed according to the preceding description, wherein the mentioned features can be present individually or in any combination.

### BRIEF DESCRIPTION OF THE DRAWINGS

Further advantages of the invention are described in the following exemplary embodiment. Wherein:

FIG. 1 shows a schematic, perspective side view of a pair of eyeglasses,

FIG. 2 shows a schematic top view of the eyeglasses in the area of an eyeglass temple,

FIG. 3 shows an eyeglass charging system with a pair of eyeglasses according to FIGS. 1 and 2 and a charging station, into which the eyeglasses have been placed, in a schematic longitudinal sectional representation,

FIG. 4 shows a perspective back view of the eyeglasses from FIGS. 1 and 2 in detail,

FIG. 5 shows a perspective view of the eyeglass charging system from FIG. 3 in detail, which comprises the eyeglasses according to FIGS. 1, 2 and 4, and the charging station, and

FIG. 6 shows a longitudinal section through the eyeglass charging system from FIGS. 3 and 5 in detail.

### DETAILED DESCRIPTION OF EXEMPLARY EMBODIMENTS OF THE INVENTION

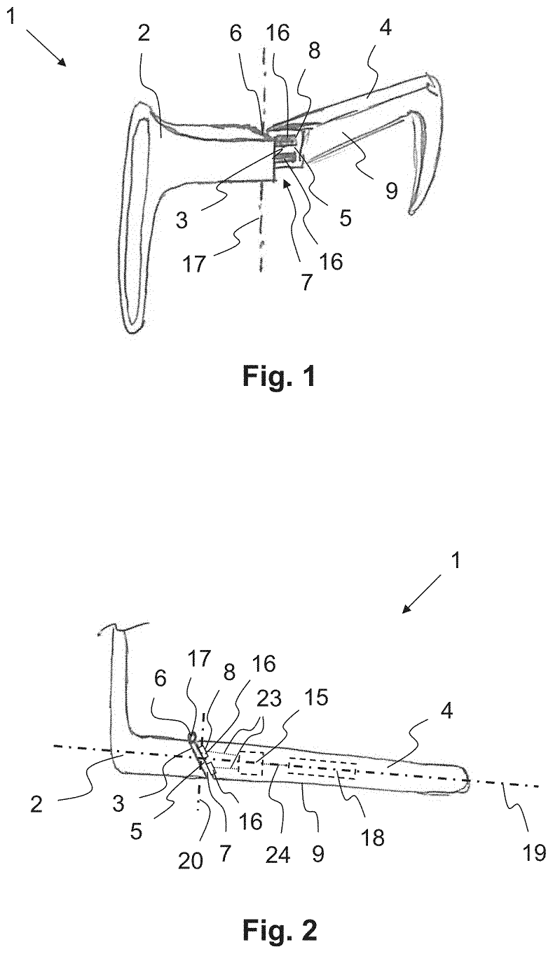

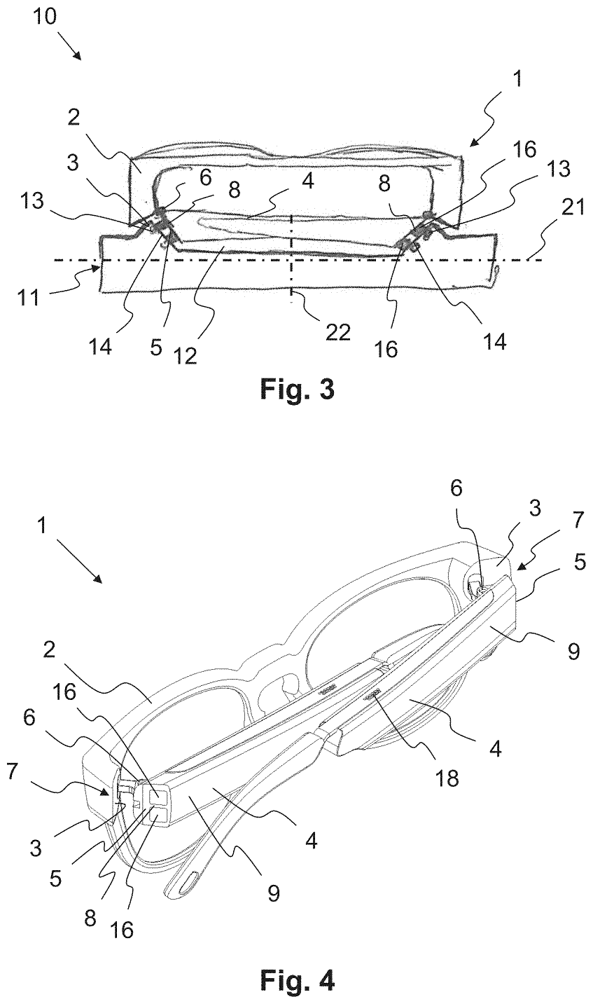

Each of FIGS. 1, 2 and 4 shows in a view taken from a different viewpoint, a pair of eyeglasses 1 for the input/output of visual and/or auditory information, with a lens holder 2 for holding eyeglass lenses. As shown in FIG. 2 for example, the lens holder 2 defines at least one first joint surface 3. Moreover, the eyeglasses 1 comprise at least one, preferably two, eyeglass temple(s) 4. Each eyeglass temple 4 defines a second joint surface 5. The second joint surface 5 is configured in a complementary manner so as to correspond to the first joint surface 3. The eyeglasses 1 comprise a temple joint 6 associated with each eyeglass temple 4, via which the eyeglass temple 4 is articulatedly connected to the lens holder 2, in particular in a joint area 7 of the eyeglasses 1. The eyeglass temple 4 is connected to the lens holder 2 in such a way that the two joint surfaces 3, 5 are folded away from each other in the folded state of the eyeglass temple 4 shown in FIG. 3 and are folded toward each other in the unfolded state of the eyeglass temple 4 shown in FIG. 2. Preferably, in the unfolded state as shown in FIG. 2, the two joint surfaces 3, 5 rest against one another at least in one area such as the joint area 7.

The eyeglasses 1 also comprise an energy store 15, which desirably is arranged in the eyeglass temple 4 as schematically shown in dashed outline in FIG. 2. However, for the sake of avoiding undue complication of the drawings, the energy store 15 is not explicitly represented in the remaining figures. Though not separately depicted in the figures, the energy store 15 also can be arranged in the lens holder 2.

As shown in FIG. 2 for example, the eyeglasses 1 comprise a charging interface 8 for charging the energy store 15. The charging interface 8 is electrically connected to the energy store 15 via electrical connections 23 indicated schematically by the dotted lines so labelled in FIG. 2. The charging interface 8 is arranged at the first joint surface 3 and/or the second joint surface 5. As a result, the charging interface 8 is covered from view by the opposite joint surface 3, 5 in the unfolded state of the eyeglass temple 4. Advantageously, as a result, the aesthetic appearance of the eyeglasses is not negatively affected by the visibility of the charging interface 8. Moreover, as a result, the charging interface 8 arranged in the one joint surface 5 is protected from soiling and damage by the opposite, other joint surface 3.

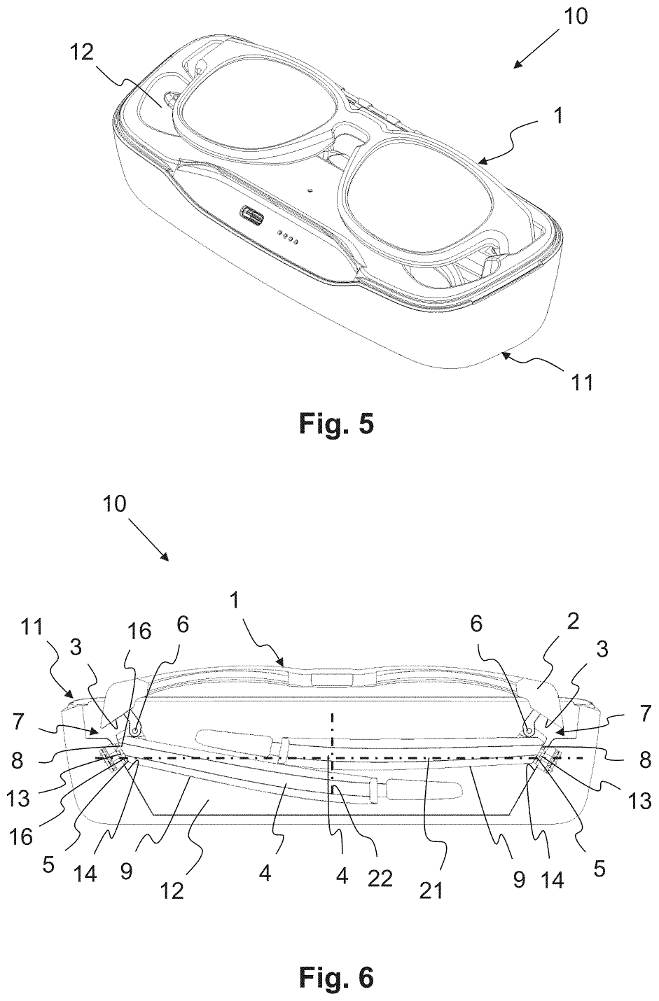

The charging interface 8 comprises at least one charging contact 16, as is apparent in FIGS. 1, 2, 3, 4, and 6. The charging contact 16 is intended for a corresponding current interface 13 of a charging station 11 shown in FIGS. 3, 5, and 6. The charging contact 16 is configured to be flat and/or configured to form or include a metal surface. Preferably, two charging contacts 16 are arranged, in particular next to one another, in the first joint surface 3 and/or the second joint surface 5. In the exemplary embodiment represented in the figures, two charging contacts 16 are provided at each of the two eyeglass temples 4. Furthermore, the first joint surface 3 and/or the second joint surface 5 are/is configured to be a flat surface. As schematically shown in FIG. 2, the first joint surface 3 and/or the second joint surface 5 extend(s) obliquely with respect to a longitudinal axis 19 and/or transverse axis 20 of the eyeglass temple 4. Furthermore, as schematically shown in FIGS. 1 and 2, the first joint surface and/or the second joint surface 5 extend(s) radially with respect to a joint axis 17 of the temple joint 4. The first joint surface 3 and/or the second joint surface 5 are/is designed to be flat.

As shown in FIGS. 1 and 2, the first joint surface 3 and/or the second joint surface 5 are/is slanted by an angle of less than or more than 90° with respect to a temple outer side 9 of the eyeglass temple 4. In the represented exemplary embodiment, the second joint surface 5 is slanted by more than 90° with respect to the temple outer side 9 in a top view, as arises, in particular, from FIGS. 2 and 6. Therefore, an obtuse angle is formed between the temple outer side 9 and the second joint surface 5. The first joint surface 3 is slanted in a complementary manner corresponding to the second joint surface 5. Accordingly, an acute angle is formed between the outer side of the lens holder 2, which preferably continues the temple outer side 9 according to the represented exemplary embodiment, and the first joint surface 3.

The eyeglasses 1 comprise an audio system 18 as schematically shown in dashed outline in FIG. 2, in particular with a MEMS loudspeaker, which is electrically connected to the energy store 15 via an electrical connection 24 indicated schematically by the dotted line so labelled in FIG. 2. Sound outlets of the audio system 18 are represented by a clustered pattern of small circles in FIG. 4. These sound outlets are located on the top side of the eyeglass temple 4 shown in FIG. 4 as well as on the underside of the eyeglass temple 4, the underside being hidden from view in FIG. 4. In order to avoid unduly complicating the drawings, the audio system 18 is not explicitly represented in the remaining figures.

FIGS. 3, 5 and 6 show an eyeglass charging system 10 with the eyeglasses 1 shown in FIGS. 1, 2 and 4 for the input/output of visual and/or auditory information. FIGS. 3 and 6 show a longitudinal sectional view of the eyeglass charging system 10. The eyeglass charging system 10 comprises a charging station 11 that is configured for receiving the eyeglasses 1 and for charging the eyeglasses 1. The charging station 11 desirably can comprise a hinged cover (not represented in the present case). The eyeglasses 1 are designed according to the preceding description, wherein the mentioned features can be present individually or in any combination.

The charging station 11 defines an eyeglass receptacle 12, into which the eyeglasses 1, in the folded state, can be placed. Accordingly, the configuration of the eyeglass receptacle 12 provides a cavity, into which the eyeglasses 1 can be placed. Moreover, as shown in FIGS. 3 and 6, the charging station 11 comprises at least one current interface 13 for charging the energy store 15 of the eyeglasses 1. The charging station 11 comprises at least one charging surface 14, in which the current interface 13 is arranged. In order to ensure reliable electrical contact between the current interface 13 and the proximally associated joint surface 3, 5 of the eyeglass temple 4, the charging surface 14 is configured in a manner corresponding to the proximally associated joint surface 3, 5 of the eyeglass temple 4. For this purpose, as schematically shown in FIGS. 3 and 6, the charging surface 14 extends obliquely with respect to a longitudinal axis 21 and/or vertical axis 22 of the charging station 11. The current interface 13 is preferably designed to be magnetic. According to the present exemplary embodiment, the charging station 11 comprises a first current interface 13, which is associated with the one eyeglass temple 4, and a second current interface 13, which is associated with the other eyeglass temple 4. As arises, in particular, from FIGS. 3 and 6, in the folded state of the two eyeglass temples 4, the two second joint surfaces 5 of the two eyeglass temples 4, which are spaced apart from one another in the longitudinal direction of the lens holder 2, are slanted and/or arranged in a V-shaped manner with respect to one another in the represented top view of the eyeglasses 1. Moreover, the two charging surfaces 14, which are spaced apart from one another in the longitudinal direction of the charging station 11, are slanted and/or arranged in a manner corresponding to the two joint surfaces 3, 5 and, therefore, also in a V-shaped manner with respect to one another. As a result, it can be ensured that the two charging interfaces 8, in particular the charging contacts 16, of the eyeglass temples 4 reliably come into contact with the particular current interface 13 of the charging station 11 when the eyeglasses 1 are placed into the charging station 11.

The present invention is not limited to the represented and described exemplary embodiments. Modifications within the scope of the claims are also possible, as is any combination of the described features, even if they are represented and described in different parts of the description and/or in the claims or in different exemplary embodiments, provided that a contradiction of the teaching of the independent claims does not arise.

### LIST OF REFERENCE NUMERALS

1 eyeglasses
2 lens holder
3 first joint surface
4 eyeglass temple
5 second joint surface
6 temple joint
7 joint area
8 charging interface
9 temple outer side
10 eyeglass charging system
11 charging station
12 eyeglass receptacle
13 current interface
14 charging surface
15 energy store
16 charging contact
17 joint axis
18 audio system
19 longitudinal axis of temple 4
20 transverse axis of temple 4
21 longitudinal axis of charging station 11
22 vertical axis of charging station 11
23 electrical connections between energy store 15 and charging interface 8
24 electrical connection between energy store 15 and audio system 18

What is claimed is:

1. Eyeglasses for the input/output of visual and/or auditory information, the eyeglasses comprising:
a lens holder for holding eyeglass lenses, the lens holder defining a first joint surface;
a first eyeglass temple that defines a second joint surface;
a first temple joint that articulatedly connects the first eyeglass temple to the lens holder in such a way that the first and second joint surfaces are folded away from each other in a folded state of the first eyeglass temple and are folded toward each other in an unfolded state of the first eyeglass temple;
an energy store, which is arranged in the lens holder and/or the first eyeglass temple; and
a charging interface for charging the energy store, wherein the charging interface is arranged at the first joint surface and/or the second joint surface.

2. The eyeglasses as in claim 1, wherein the charging interface comprises at least one charging contact.

3. The eyeglasses as in claim 1, wherein the charging contact is configured to be flat and/or includes a metal surface.

4. The eyeglasses as in claim 1, wherein two charging contacts are arranged next to one another, in the first joint surface and/or the second joint surface.

5. The eyeglasses as in claim 1, wherein the first joint surface and/or the second joint surface are/is configured to be flat.

6. The eyeglasses as in claim 1, wherein the eyeglass temple defines a longitudinal axis and a transverse axis that is normal to the longitudinal axis, and wherein the first joint surface and/or the second joint surface extend(s) obliquely with respect to the longitudinal axis and/or the transverse axis of the eyeglass temple.

7. The eyeglasses as in claim 1, wherein the temple joint defines a joint axis and wherein the first joint surface and/or the second joint surface extend(s) radially with respect to the joint axis.

8. The eyeglasses as in claim 1, wherein the eyeglass temple defines a temple outer side and wherein the first joint surface and/or the second joint surface are/is slanted by an angle of more or less than 90° with respect to the temple outer side.

9. The eyeglasses as in claim 1, further comprising:
a second eyeglass temple that defines a third joint surface, wherein the lens holder defining a longitudinal direction and a fourth joint surface spaced apart in the longitudinal direction from the second joint surface;
a second temple joint that articulatedly connects the second eyeglass temple to the lens holder in such a way that the third and fourth joint surfaces are folded away from each other in a folded state of the second eyeglass temple and are folded toward each other in an unfolded state of the second eyeglass temple;
wherein, in the folded state of the first and second eyeglass temples, the respective first and third joint surfaces of the respective first and second eyeglass temples, are slanted and/or arranged in a V-shaped manner with respect to one another in a top view of the eyeglasses.

10. The eyeglasses as in claim 1, further comprising an audio system with a MEMS loudspeaker, which is electrically connected to the energy store.

11. A charging station for charging a pair of eyeglasses for the input/output of visual and/or auditory information, the charging station comprising:
an eyeglass receptacle configured for receiving the pair of eyeglasses, in the folded state;
a charging surface carried by the eyeglass receptacle; and
a current interface arranged in the charging surface.

12. The charging station as in claim 11, wherein the charging station defines a longitudinal axis and a vertical axis that is normal to the longitudinal axis, and wherein the charging surface extends obliquely with respect to the longitudinal axis and/or the vertical axis of the charging station.

13. The charging station as in claim 11, wherein the current interface includes a magnetic element.

14. The charging station as in claim 11, wherein the charging station defines a longitudinal axis and further comprises two charging surfaces spaced apart from one another in the longitudinal direction, wherein the two charging surfaces are slanted with respect to one another.

15. The charging station as in claim 14, wherein the two charging surfaces are arranged in a V-shaped manner with respect to one another.

16. An eyeglass charging system, comprising:
a pair of eyeglasses configured for the input/output of visual and/or auditory information, the eyeglasses including:
a lens holder for holding eyeglass lenses, the lens holder defining a first joint surface,
a first eyeglass temple that defines a second joint surface,
a temple joint that articulatedly connects the eyeglass temple to the lens holder in such a way that the first and second joint surfaces are folded away from each other in a folded state of the eyeglass temple and are folded toward each other in an unfolded state of the eyeglass temple,
an energy store, which is arranged in the lens holder and/or the eyeglass temple, and
a charging interface for charging the energy store, wherein the charging interface is arranged at the first joint surface and/or the second joint surface; and
a charging station for charging the eyeglasses, the charging station including:
an eyeglass receptacle configured for receiving the pair of eyeglasses, in the folded state,
a charging surface carried by the eyeglass receptacle, and
a current interface arranged in the charging surface.
